(19) United States
(12) Patent Application Publication
(10) Pub. No.: US 2025/0020985 A1
(43) Pub. Date: Jan. 16, 2025

(54) ILLUMINATION SYSTEM AND PROJECTION DEVICE

(71) Applicant: Coretronic Corporation, Hsin-Chu (TW)

(72) Inventor: Yu-Hsiang Deng, Hsin-Chu (TW)

(73) Assignee: Coretronic Corporation, Hsin-Chu (TW)

(21) Appl. No.: 18/769,409

(22) Filed: Jul. 11, 2024

(30) Foreign Application Priority Data
Jul. 13, 2023 (CN) 202310856278.8

(51) Int. Cl. G03B 21/20

(52) U.S. Cl. CPC G03B 21/204; G03B 21/208

(57) ABSTRACT

An illumination system is configured to provide an illumination beam. The illumination system includes an excitation light source, a wavelength conversion element, first and second light splitting elements, and first and second light homogenizing elements. The excitation light source is configured to provide a laser beam. The wavelength conversion element sequentially converts the laser beam into at least one excited beam and reflects the laser beam or allows the laser beam to pass through. The first light splitting element is configured to allow the laser beam to pass through to generate a first color beam and allow at least another portion of the at least one excited beam to pass through. The second light splitting element is configured to allow the laser beam to pass through to generate a second color beam. The first and second light homogenizing elements are disposed on transmission paths of the first and second color beams respectively. The illumination beam includes the first color beam, the second color beam, and the laser beam. The illumination system includes only a single rotating wheel.

### CROSS-REFERENCE TO RELATED APPLICATION

This application claims the priority benefit of China application serial no. 202310856278.8, filed on Jul. 13, 2023. The entirety of the above-mentioned patent application is hereby incorporated by reference herein and made a part of this specification.

### BACKGROUND

### Technical Field

The disclosure relates to an illumination system and a projection device.

### Description of Related Art

A projection device is a display device used to generate large-size images. With the evolution and innovation of technology, it has been continuously improved. An imaging principle of the projection device is to convert an illumination beam generated by an illumination system into an image beam through a light valve, and then project the image beam to a projection target (such as a screen or a wall) through a projection lens to form a projection image. In addition, with requirements of the market for the projection device, such as brightness, color saturation, service life, non-toxic and environmental protection, the illumination system has evolved from an ultra-high-performance lamps (UHP lamp) and a light-emitting diode (LED) to the most advanced laser diode (LD) light source.

In the current optical architecture, the illumination system is required to be provided with two or more color wheel modules, one of which is a wavelength conversion color wheel with phosphor, and another is a color separation filter color wheel. However, such a configuration makes it impossible to adjust light combination individually when a projected white image is biased toward a specific wavelength range (such as reddish or greenish). In addition, using two or more color wheel modules will cause excessive noise and high cost.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an illumination system configured to provide an illumination beam. The illumination system includes an excitation light source, a wavelength conversion element, a first light splitting element, a second light splitting element, a first light homogenizing element, and a second light homogenizing element. The excitation light source is configured to provide a laser beam. The wavelength conversion element includes a rotating wheel disposed on a transmission path of the laser beam from the excitation light source, by rotating the rotating wheel, the wavelength conversion sequentially convert the laser beam into at least one excited beam and reflect the laser beam or allow the laser beam to pass through. The first light splitting element is disposed on the transmission path of the laser beam from the excitation light source and a transmission path of the at least one excited beam from the wavelength conversion element to allow the laser beam to pass through, reflect at least a portion of the at least one excited beam to generate a first color beam, and allow at least another portion of the at least one excited beam to pass through. The second light splitting element is disposed on the transmission path of the laser beam from the excitation light source and a transmission path of the at least another portion of the at least one excited beam from the wavelength conversion element to allow the laser beam to pass through and reflect the at least another portion of the at least one excited beam to generate a second color beam. A waveband of the at least one excited beam includes a waveband of the first color beam and a waveband of the second color beam. The first light homogenizing element is disposed on a transmission path of the first color beam from the first light splitting element. The second light homogenizing element is disposed on a transmission path of the second color beam from the second light splitting element. The illumination beam includes the first color beam, the second color beam, and the laser beam. The illumination system includes only the single rotating wheel.

The disclosure further provides a projection device, including an illumination system, at least one light valve, and a projection lens. The illumination system is configured to provide an illumination beam. The illumination system includes an excitation light source, a wavelength conversion element, a first light splitting element, a second light splitting element, a first light homogenizing element, and a second light homogenizing element. The excitation light source is configured to provide a laser beam. The wavelength conversion element includes a rotating wheel disposed on a transmission path of the laser beam from the excitation light source, by rotating the rotating wheel, the wavelength conversion sequentially convert the laser beam into at least one excited beam and reflect the laser beam or allow the laser beam to pass through. The first light splitting element is disposed on the transmission path of the laser beam from the excitation light source and a transmission path of the at least one excited beam from the wavelength conversion element to allow the laser beam to pass through, reflect at least a portion of the at least one excited beam to generate a first color beam, and allow at least another portion of the at least one excited beam to pass through. The second light splitting element is disposed on the transmission path of the laser beam from the excitation light source and a transmission path of the at least another portion of the at least one excited beam from the wavelength conversion element to allow the laser beam to pass through and reflect the at least another portion of the at least one excited beam to generate a second color beam. A waveband of the at least one excited beam includes a waveband of the first color beam and a waveband of the second color beam. The first light homogenizing element is disposed on a transmission path of the first color beam from the first light splitting element. The second light homogenizing element is disposed on a transmission path of the second color beam from the second light splitting element. The illumination beam includes the first color beam, the second color beam, and the laser beam. The illumination system includes only the single rotating wheel. The at least one light valve is disposed on a transmission path of the illumination beam to convert the illumination beam into an image beam. The projection lens is disposed on a transmission path of the image beam to project the image beam out of the projection device.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic view of a projection device according to an embodiment of the disclosure.

FIGS. 2A to 2D are schematic views of a projection device at different timings according to an embodiment of the disclosure.

FIG. 3 is a schematic view of a wavelength conversion element according to an embodiment of the disclosure.

FIGS. 4A to 4D are schematic views of a projection device at different timings according to another embodiment of the disclosure.

FIG. 5 is a schematic view of a wavelength conversion element according to another embodiment of the disclosure.

FIGS. 6A to 6D are schematic views of a projection device at different timings according to another embodiment of the disclosure.

FIGS. 7A to 7D are schematic views of a projection device at different timings according to another embodiment of the disclosure.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure provides an illumination system and a projection device, which may achieve effects of controlling light beams in different wavebands and having good uniformity and color uniformity using only a single rotating wheel.

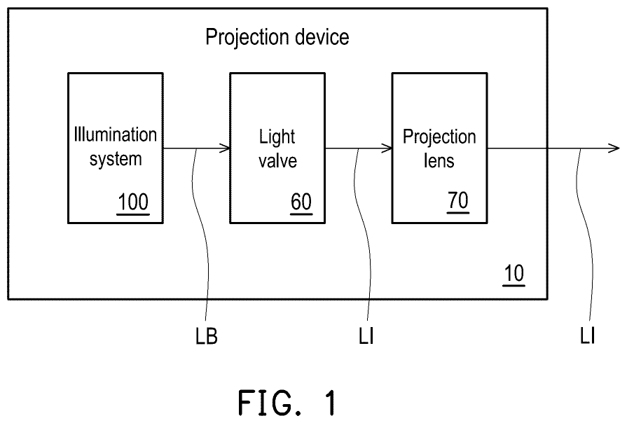

FIG. 1 is a schematic view of a projection device according to an embodiment of the disclosure Referring to FIG. 1, in this embodiment, a projection device 10 is provided, which includes an illumination system 100, at least one light valve 60, and a projection lens 70. The illumination system 100 is configured to provide an illumination beam LB. The at least one light valve 60 is disposed on a transmission path of the illumination beam LB to convert the illumination light beam LB into an image beam L1. The projection lens 70 is disposed on a transmission path of the image beam L1, and is configured to project the image beam L1 out of the projection device 10 to a projection target (not shown), such as a screen or a wall.

The light valve 60 is, for example, a reflective light modulator such as a liquid crystal on silicon panel (LCoS panel) or a digital micro-mirror device (DMD). In some embodiments, the light valve 60 may also be a transmissive light modulator such as a transparent liquid crystal panel, an electro-optical modulator, a magneto-optic modulator, or an acousto-optic modulator (AOM). The disclosure does not limit a form and type of the light valve 60. Regarding a method of the light valve 60 converting the illumination beam LB into the image beam L1, detailed steps and embodiments of the method may be sufficiently taught, suggested, and implemented by persons with ordinary knowledge in the art. Thus, details in this regard will not be further reiterated in the following. In this embodiment, the number of light valves 60 is one. For example, a single digital micro-mirror device is used. However, in other embodiments, there may be multiple light valves, and the disclosure is not limited thereto.

The projection lens 70 includes, for example, a combination of one or more optical lenses with diopter, such as various combinations of non-planar lenses including, for example, biconcave lenses, biconvex lenses, concave-convex lenses, convex-concave lenses, plane-convex lenses, and plane-concave lenses, etc. In an embodiment, the projection lens 70 may further include planar optical lenses to project the image beam L1 from the light valve 60 to the projection target in a reflective manner. The disclosure does not limit a form and type of the projection lens 70.

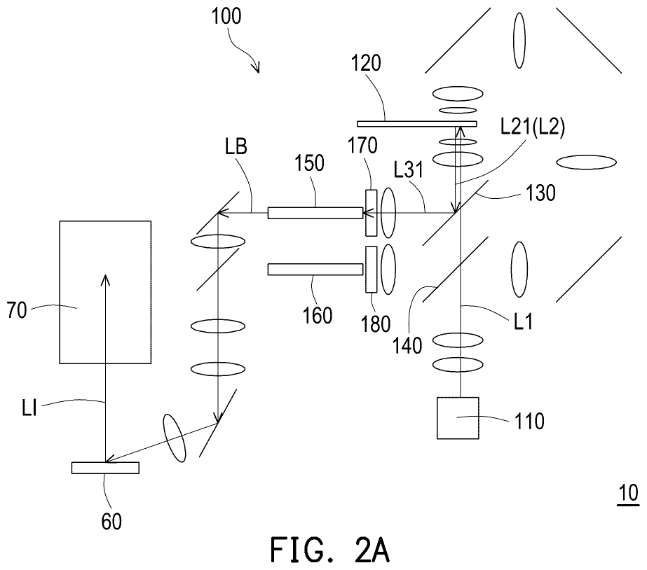

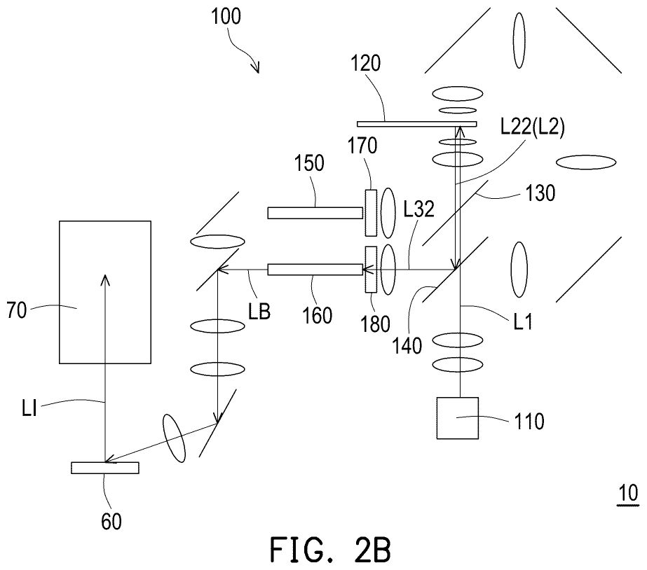

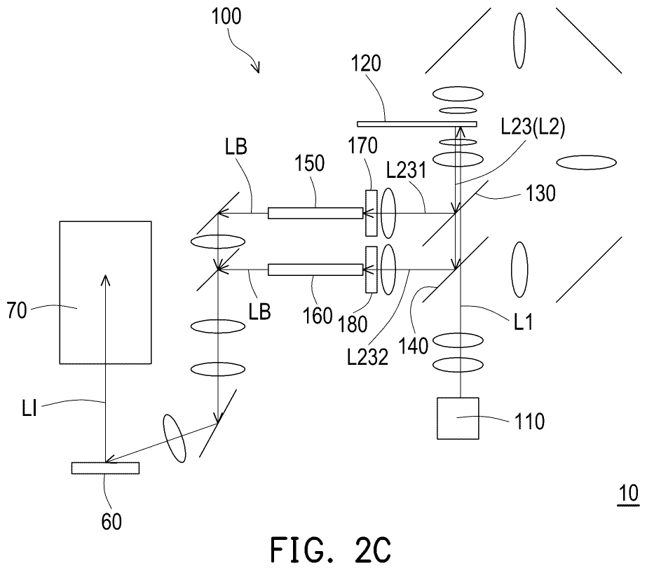

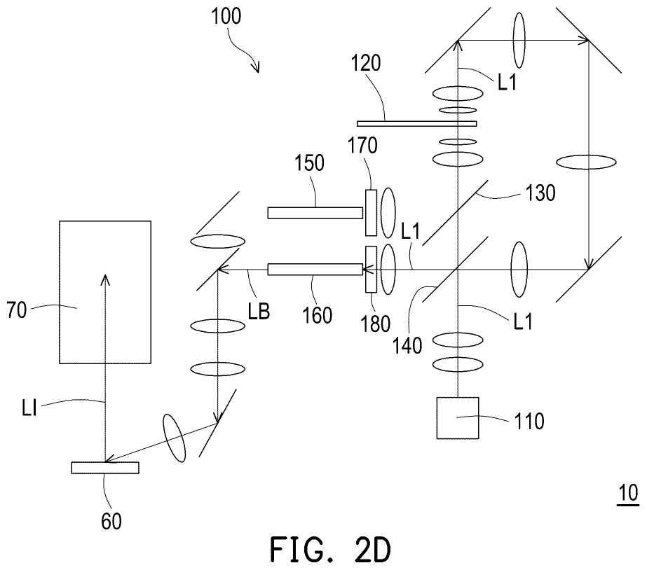

FIGS. 2A to 2D are schematic views of a projection device at different timings according to an embodiment of the disclosure. Referring to FIGS. 2A to 2D, the illumination system 100 includes an excitation light source 110, a wavelength conversion element 120, a first light splitting element 130, a second light splitting element 140, a first light homogenizing element 150, and a second light homogenizing element 160. The excitation light source 110 is configured to provide a laser beam L1. The excitation light source 110 is, for example, a blue laser diode (LD), which is configured to provide the blue laser beam L1.

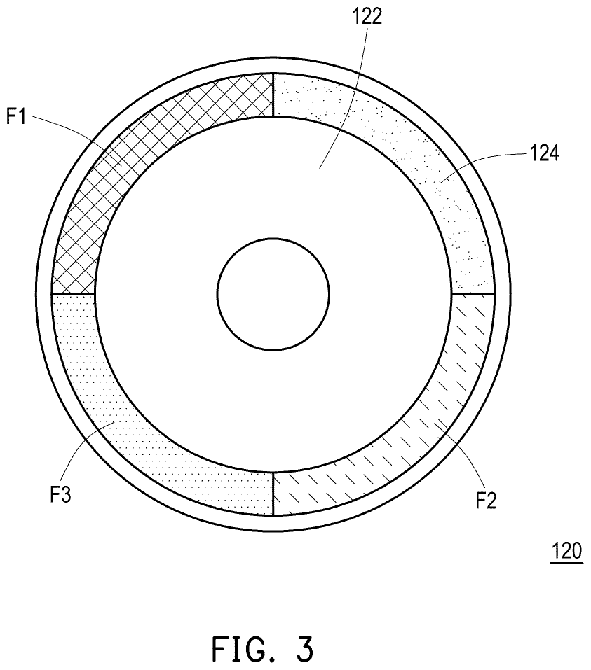

FIG. 3 is a schematic view of a wavelength conversion element according to an embodiment of the disclosure. Referring to FIGS. 2A to 3, the wavelength conversion element 120 shown in FIG. 3 may be applied to at least the illumination system 100 in FIGS. 2A to 2D. Therefore, the following description takes this as an example. The wavelength conversion element 120 includes a rotating wheel 122 disposed on a transmission path of the laser beam L1 from the excitation light source 110, so as to, by rotating the rotating wheel 122, the wavelength conversion 120 sequentially convert the laser beam L1 into at least one excited beam L2 and reflect the laser light beam L1 or allow the laser beam L1 to pass through. In detail, the rotating wheel 122 of the wavelength conversion element 120 has an excitation area and a non-excitation area 124. At least one wavelength conversion material is disposed in the excitation zone. When the laser beam L1 is incident to the excitation area, the laser beam L1 may be converted into the at least one excited beam L2, and when the laser beam L1 is incident to the non-excitation area, the non-excitation area may reflect the laser beam L1 or allow the laser beam L1 to pass through. For example, in an embodiment, the excitation area of the wavelength conversion element 120 only has a single type of the wavelength conversion material, such as a yellow fluorescent material, to convert the laser beam L1 in a blue waveband into the excited beam L2 in a yellow waveband. A central wavelength range of the excited beam L2 is, for example, between 525 nanometers and 575 nanometers, and a portion of the excited beam L2 is separated by a subsequent optical element to generate light beams in red, green, or other wavebands. However, the disclosure is not limited thereto.

For another example, in another embodiment, the wavelength conversion element 120 has two different types of wavelength conversion materials, such as an orange fluorescent material and a green fluorescent material, and sequentially converts the laser beam L1 into a first excited beam in an orange waveband and a second excited beam in a green waveband. A central wavelength range of the first excited beam in the orange waveband is, for example, between 550 nanometers and 600 nanometers, and a central wavelength range of the second excited beam in the green waveband is, for example, between 500 nanometers and 550 nanometers. In other words, in this embodiment, the excited beam L2 includes at least one of the first excited beam and the second excited beam. In addition, in still another embodiment, the wavelength conversion element 120 has two wavelength conversion materials, such as a red fluorescent material and the green fluorescent material, and sequentially converts the laser beam L1 into the first excited beam in a red waveband and the second excited beam in the green waveband.

In the embodiments of FIGS. 2A to 3, the excitation area of the wavelength conversion element 120 has three different types of wavelength conversion materials, such as an orange fluorescent material F1, a green fluorescent material F2, and a yellow fluorescent material F3, and the orange fluorescent material F1, the green fluorescent material F2, and the yellow fluorescent material F3 in the excitation area enter the transmission path of the laser beam L1 sequentially to respectively convert the laser beam L1 into a first excited beam L21 in the orange waveband (as shown in FIG. 2A), a second excited beam L22 in the green waveband (shown in FIG. 2B), and a third excited beam L23 in the yellow waveband (shown in FIG. 2C). In other words, in this embodiment, the excited beam L2 includes at least one of the first excited beam L21, the second excited beam L22, and the third excited beam L23. The third excited beam L23 may be used to increase brightness of the illumination beam LB output by the illumination system 100. In addition, in another embodiment, the orange fluorescent material F1 may also be replaced with the red fluorescent material to convert the laser beam L1 into the first excited beam in the red waveband. The configuration of the wavelength conversion materials in the excitation area is not limited to the above. On the other hand, in this embodiment, the non-excitation area 124 of the wavelength conversion element 120 is provided with, for example, light-transmitting glass to allow the laser beam L1 to pass through, as shown in FIG. 2D. In another embodiment, the non-excitation area 124 of the wavelength conversion element 120 has a hollow structure, for example. That is, the non-excitation area 124 is not provided with any optical elements, and has an area completely penetrating the rotating wheel 122 for the laser beam L1 incident to the non-excitation area 124 to pass through. In addition, the configuration of the non-excitation area 124 of the wavelength conversion element 120 is not limited to the above.

Referring to FIGS. 2A to 2D, the first light splitting element 130 is disposed on the transmission path of the laser beam L1 from the excitation light source 110 and a transmission path of the excited beam L2 from the wavelength conversion element 120 to allow the laser beam L1 to pass through, and reflect at least a portion of the excited beam L2 to generate a first color beam L31, and allows at least another portion of the excited beam L2 to pass through. The second light splitting element 140 is disposed on the transmission path of the laser beam L1 from the excitation light source 110 and a transmission path of the at least another portion of the excited beam L2 from the wavelength conversion element 120 to allow the laser beam L1 to pass through and reflect the at least another portion of the excited beam L2 to generate a second color beam L32. A waveband of the excited beam L2 includes a waveband of the first color beam L31 and a waveband of the second color beam L32. In other words, a waveband of the first excited beam L21 includes the waveband of the first color beam L31, and a waveband of the second excited beam L22 includes the waveband of the second color beam L32.

Specifically, in this embodiment, the first light splitting element 130 is, for example, a reflective red dichroic mirror, and the second light splitting element 140 is, for example, a reflective green-red dichroic mirror. In other words, in this embodiment, a reflection wavelength range of the second light splitting element 140 includes a reflection wavelength range of the first light splitting element 130. In this way, the manufacturing difficulty of the second light splitting element 140 may be reduced. In another embodiment, the reflection wavelength range of the second light splitting element 140 may not include the reflection wavelength range of the first light splitting element 130. For example, the first light splitting element 130 is the reflective red dichroic mirror, and the second light splitting element 140 is a reflective green dichroic mirror. However, the disclosure is not limited thereto.

In the timing shown in FIG. 2A, when the laser beam L1 is transmitted to the orange fluorescent material F1 of the wavelength conversion element 120 (refer to FIG. 3), the wavelength conversion element 120 converts the laser beam L1 into the first excited beam L21 in the orange waveband, and the first excited beam L21 is then transmitted by the wavelength conversion element 120 to the first light splitting element 130 to be reflected by the first light splitting element 130. In the timing shown in FIG. 2B, when the laser beam L1 is transmitted to the green fluorescent material F2 of the wavelength conversion element 120 (refer to FIG. 3), the wavelength conversion element 120 converts the laser beam L1 into the second excited beam L22 in the green waveband, and the second excited beam L22 is then transmitted by the wavelength conversion element 120 to pass through the first light splitting element 130, and then transmitted to the second light splitting element 140 to be reflected by the second light splitting element 140. In the timing shown in FIG. 2C, when the laser beam L1 is transmitted to the yellow fluorescent material F3 of the wavelength conversion element 120 (refer to FIG. 3), the wavelength conversion element 120 converts the laser beam L1 into the third excited beam L23 in the yellow waveband, and the third excited beam L23 is then transmitted by the wavelength conversion element 120 to the first light splitting element 130. The third excited beam L23 in the yellow waveband includes a first portion L231 (for example, a red light portion) and a second portion L232 (for example, a green light portion). When the third excited beam L23 in the yellow waveband is transmitted to the first light splitting element 130, the first portion L231 of the third excited beam L23 is reflected by the first light splitting element 130, while the second portion L232 of the third excited beam L23 passes through the first light splitting element 130, and is transmitted to the second light splitting element 140. The second portion L232 of the third excited beam L23 is reflected by the second light splitting element 140. In addition, in the timing shown in FIG. 2D, the laser beam L1 passing through the wavelength conversion element 120 is guided by at least one optical element to be transmitted and pass through the second light splitting element 140. In another embodiment, the laser beam L1 from the wavelength conversion element 120 may also be guided by the at least one optical element to be transmitted and pass through the first light splitting element 130.

The first light homogenizing element 150 is disposed on a transmission path of the first color beam L31 from the first light splitting element 130, and the second light homogenizing element 160 is disposed on a transmission path of the second color beam L32 from the second light splitting element 140. The first light homogenizing element 150 and the second light homogenizing element 160 are adapted to adjust a shape of a light spot of the first color beam L31 and the second color beam L32 respectively, so that the shape of the light spot of the formed illumination light beam LB may match a shape of a working area of the light valve 60 (for example rectangular), and that the light spot has consistent or close light intensity everywhere, and the light intensity of the illumination beam LB is uniform. In this embodiment, the first light homogenizing element 150 and the second light homogenizing element 160 are, for example, integration rods. However, in other embodiments, the first light homogenizing element 150 and the second light homogenizing element 160 may also be other suitable types of optical elements, such as lens arrays. Specifically, the first light homogenizing element 150 and the second light homogenizing element 160 may also be a fly eye lens array, but the disclosure is not limited thereto. In this embodiment, light incident surface areas of the first light homogenizing element 150 and the second light homogenizing element 160 may be designed to be the same. However, in other embodiments, the light incident surface area of the first light homogenizing element 150 and the light incident surface area of the second light homogenizing element 160 may be designed to be different. The larger the light incident surface area, the larger an output angle of the light beam after homogenization. Specifically, the light incident surface area of the first light homogenizing element 150 and the light incident surface area of the second light homogenizing element 160 may be designed correspondingly according to area proportions of different types of wavelength conversion materials in the wavelength conversion element 120. In this way, different light incident surface areas may be designed for light beams of different wavelengths with different divergence angles, so that the light beams of different wavelengths may be optimized and adjusted to improve optical quality of the illumination beam LB.

In addition, the first light homogenizing element 150 and the second light homogenizing element 160 may also be used to adjust shapes of light spots of the first portion L231 of the third excited beam L23 and the second portion L232 of the third excited beam L23. Specifically, when the excited beam L2 further includes the third excited beam L23, the first portion L231 of the third excited beam L23 is reflected by the first light splitting element 130 and then transmitted to the first light homogenizing element 150 for homogenization, while the second portion L232 of the third excited beam L23 is reflected by the second light splitting element 140 and then transmitted to the second light homogenizing element 160 for homogenization. That is to say, in the third excited beam L23 in the yellow waveband, a light path of the first portion L231 of the third excited beam L23 is the same as a light path of the first color beam L31, and a light path of the second portion L232 of the third excited beam L23 is the same as a light path of the second color beam L32. In an embodiment, after the laser beam L1 from the wavelength conversion element 120 passes through the second light splitting element 140, it also enters the second light homogenizing element 160 to be homogenized. In another embodiment, the laser beam L1 from the wavelength conversion element 120 may also enter the first light homogenizing element 150 to be homogenized after passing through the first light splitting element 130.

In this embodiment, the illumination system 100 further includes a first filter element 170 and a second filter element 180 to filter stray light in other wavebands. The first filter element 170 is disposed on the transmission path of the first color beam L31 (or the first portion L231 of the third excited beam L23) passing through the first light splitting element 130 and the first light homogenizing element 150, and the second filter element 180 is disposed on the transmission path of the second color beam L32 (or the second portion L232 of the third excited beam L23) passing through the second light splitting element 140 and the second light homogenizing element 160. In this embodiment, the first filter element 170 is, for example, a red filter, and the second filter element 180 is, for example, a green filter. For example, after entering the orange fluorescent material F1 of the wavelength conversion element 120, the laser beam L1 is converted into the first excited beam L21 in the orange waveband, and after passes through the first light splitting element 130 and the first filter element 170, light in the unnecessary waveband may be filtered out, so that the first color beam L31 has a relatively pure color as the red light portion of the illumination beam LB. Similarly, after passing through the second light splitting element 140 and the second filter element 180, the second color beam L32 may be used as the green light portion of the illumination beam LB.

Based on the descriptions in the above paragraphs, in this embodiment, the light beam transmitted through the first light homogenizing element 150 or the second light homogenizing element 160 is the illumination beam LB. The illumination beam LB includes the first color beam L31, the second color beam L32, and the laser beam L1. In other embodiments, the illumination beam LB may further include the first portion L231 of the third excited beam L23 and the second portion L232 of the third excited beam L23. In addition, it is worth mentioning that through the above configuration, only one single rotating wheel is used for the illumination system 100 to control the light beams in different wavebands and have good uniformity and color uniformity. In this way, an overall structure of the illumination system 100 may be smaller, and cost and noise are reduced, while maintaining good optical effects.

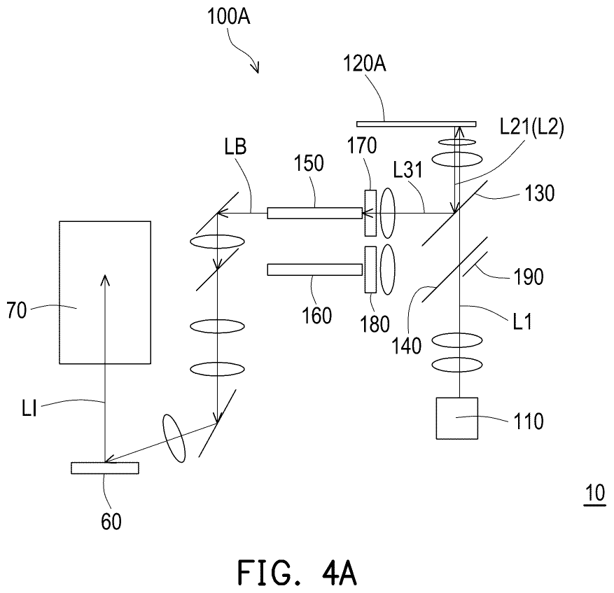

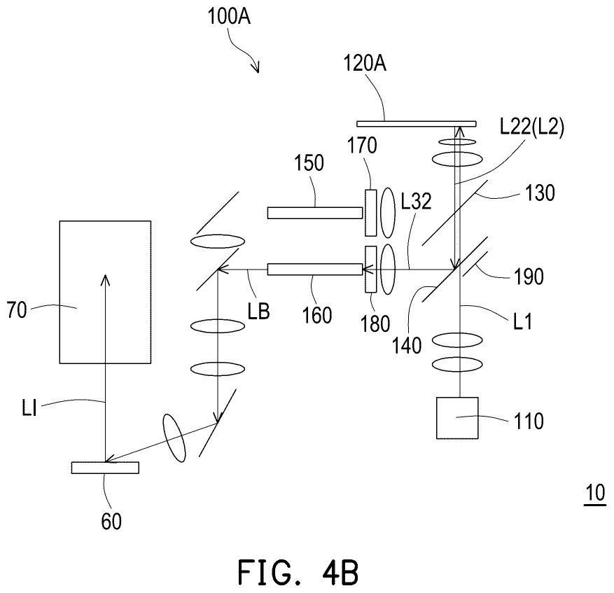

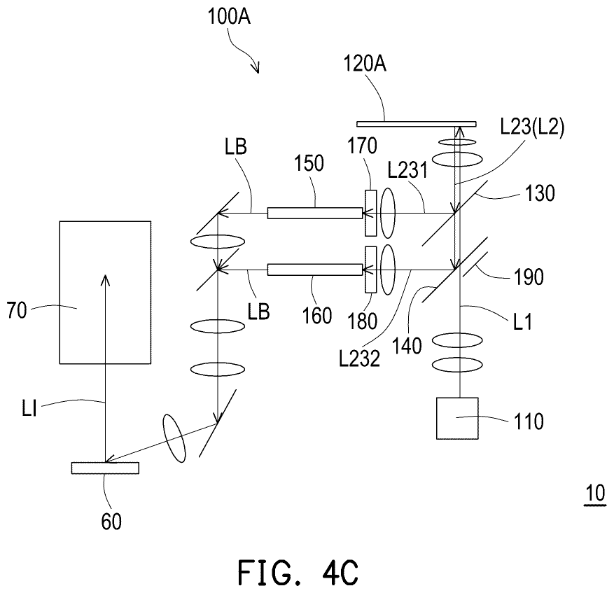

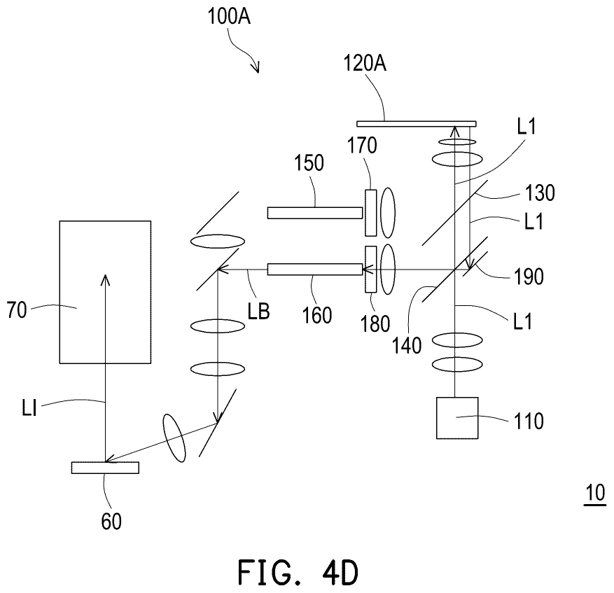

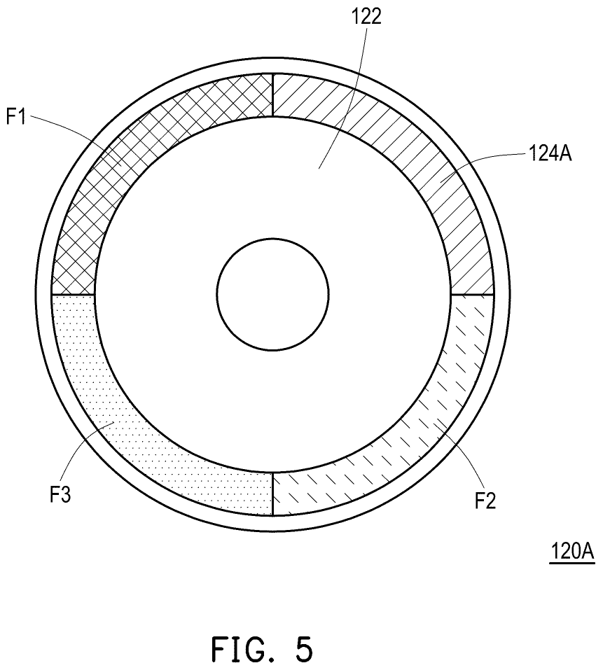

FIGS. 4A to 4D are schematic views of a projection device at different timings according to another embodiment of the disclosure. FIG. 5 is a schematic view of a wavelength conversion element according to another embodiment of the disclosure. A wavelength conversion element 120A shown in FIG. 5 may be applied to at least an illumination system 100A in FIGS. 4A to 4D. Therefore, the following description takes this as an example. Referring to FIGS. 4A to 4D, the projection device 10 shown in FIGS. 4A to 4D is similar to the projection device 10 shown in FIGS. 2A to 2D. However, the difference between the two is that in this embodiment, a non-excitation area 124A of the wavelength conversion element 120A used in the illumination system 100A has a reflective layer, for example. The reflective layer may be formed by coating a reflective material or provided with a reflective element such as a reflective mirror, but the disclosure is not limited thereto. The non-excitation area 124A is configured to reflect the laser beam L1. The illumination system 100A further includes a reflective element 190 disposed on the transmission path of the laser beam L1 from the wavelength conversion element 120A to reflect the laser beam L1, so that the laser beam L1 penetrating the second light splitting element 140 is reflected by the reflective element 190 and then passes through the second light splitting element 140 and the second light homogenizing element 160 sequentially, as shown in FIG. 4D. As shown in FIGS. 4A to 4C, when the laser beam L1 is transmitted to an excitation area of the wavelength conversion element 120A (i.e., the orange fluorescent material F1, the green fluorescent material F2, and the yellow fluorescent material F3), the light paths of the converted excited beam and the generated first color beam, second color beam, etc. are similar to FIGS. 2A to 2C. Therefore, the same details will not be repeated in the following. Therefore, in this embodiment, only one single rotating wheel is also used for the illumination system 100A to control the light beams in different wavebands and have good uniformity and color uniformity. In this way, an overall structure of the illumination system 100A may be smaller, and cost and noise are reduced, while maintaining good optical effects.

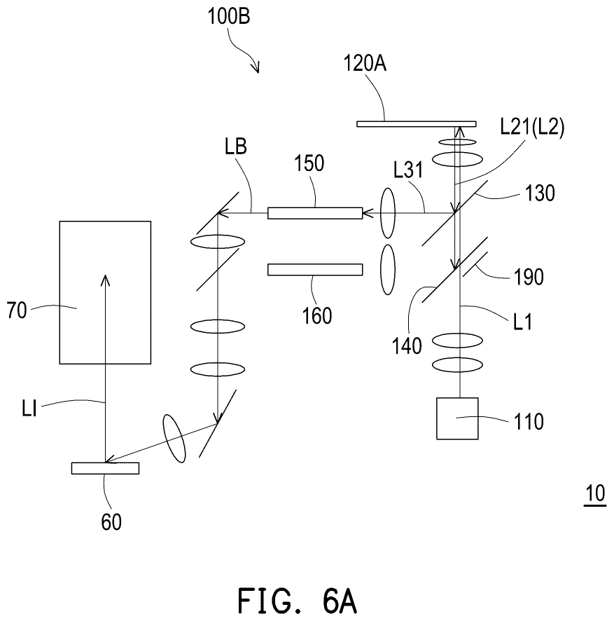

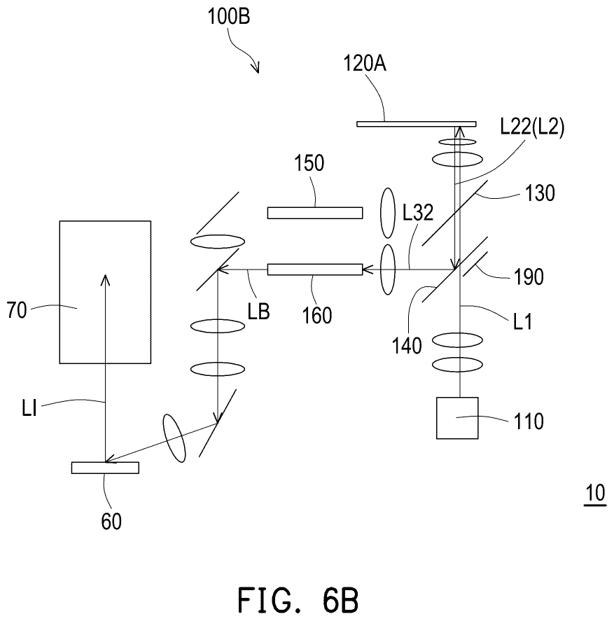

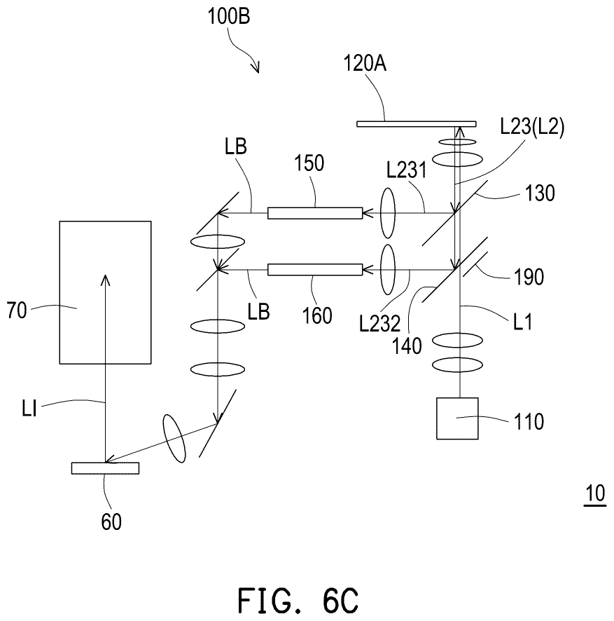

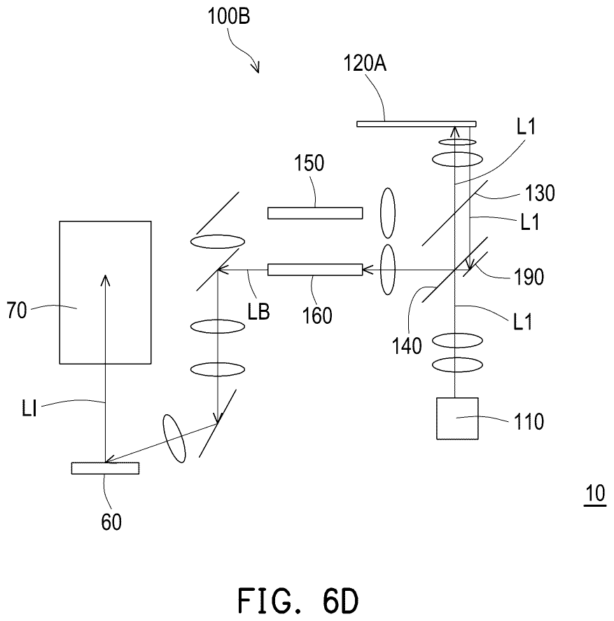

FIGS. 6A to 6D are schematic views of a projection device at different timings according to another embodiment of the disclosure. Referring to FIGS. 6A to 6D, the projection device 10 shown in FIGS. 6A to 6D is similar to the projection device 10 shown in FIGS. 4A to 4D. However, the only difference between the two is that in this embodiment, in an illumination system 100B, the first filter element 170 and the second filter element 180 are omitted. Therefore, the number of optical elements of the illumination system 100B may be reduced, thereby reducing the size. In addition, since the first filter element 170 and the second filter element 180 are omitted, reflection waveband ranges of the first light splitting element 130 and the second light splitting element 140 may be adjusted accordingly. For example, the second light splitting element 140 is changed to adopt a narrower-band reflective green dichroic mirror, but the disclosure is not limited thereto. Similarly, the design in which the first filter element and the second filter element are omitted in the illumination system may also be applied to the projection device 10 similar to that shown in FIGS. 2A to 2D, but the disclosure is not limited thereto. Therefore, in this embodiment, only one single rotating wheel is also used for the illumination system 100B to control the light beams in different wavebands and have good uniformity and color uniformity. In this way, an overall structure of the illumination system 100B may be smaller, and cost and noise are reduced, while maintaining good optical effects.

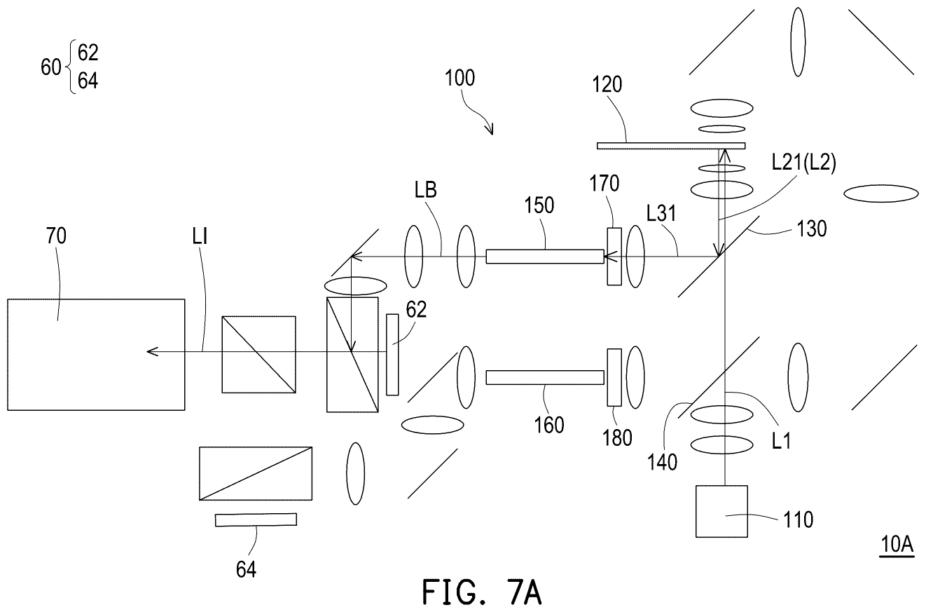

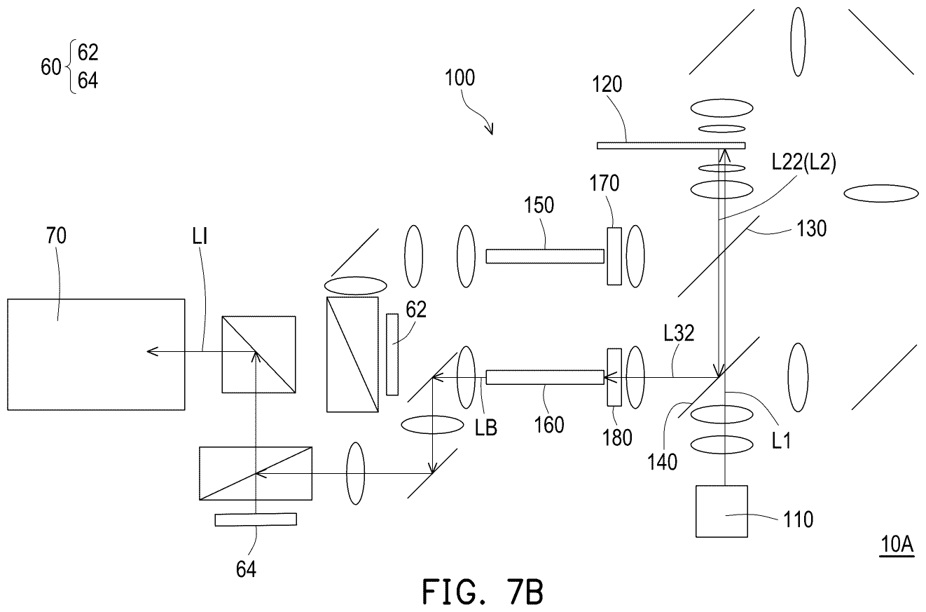

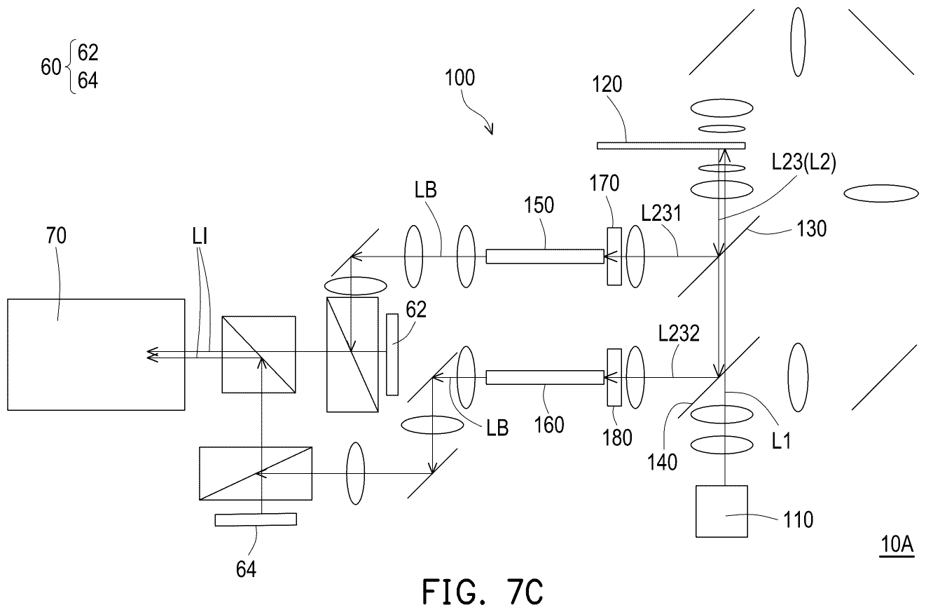

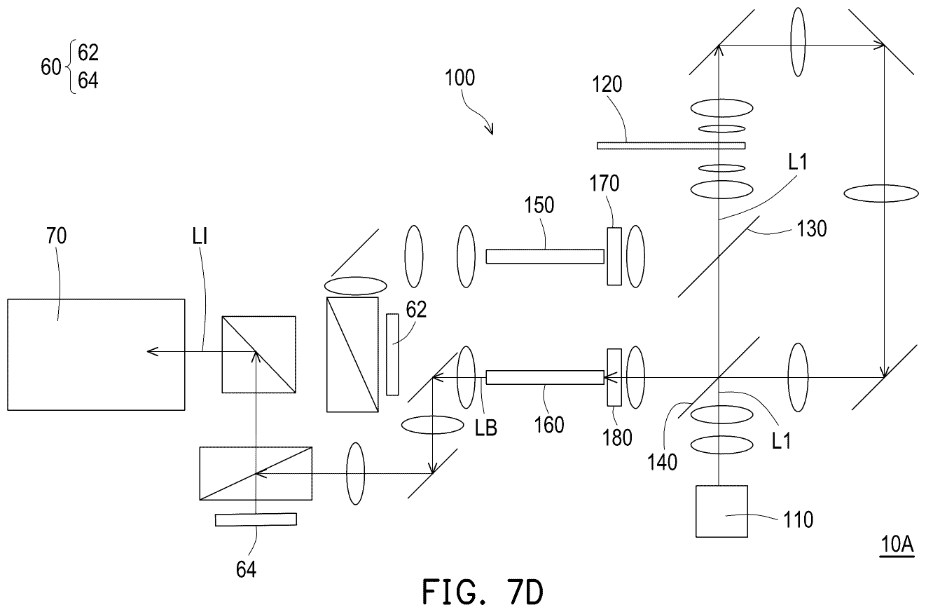

FIGS. 7A to 7D are schematic views of a projection device at different timings according to another embodiment of the disclosure. Referring to FIGS. 7A to 7D, a projection device 10A shown in FIGS. 7A to 7D is similar to the projection device 10 shown in FIGS. 2A to 2D. However, the only difference between the two is that in this embodiment, the at least one light valve 60 includes a first light valve 62 and a second light valve 64. The first light valve 62 is disposed on the transmission path of the illumination beam LB (such as the first color beam L31 or the first portion L231 of the third excited beam L23) from the first light homogenizing element 150. The second light valve 64 is disposed on the transmission path of the illumination beam LB (such as the second color beam L32 or the second portion L232 of the third excited beam L23) from the second light homogenizing element 160. Similarly, the design of disposing multiple light valves may also be applied to the projection device 10 similar to that shown in FIGS. 4A to 4D, but the disclosure is not limited thereto. Therefore, in this embodiment, only one single rotating wheel is also used for the illumination system 100 to control the light beams in different wavebands and have good uniformity and color uniformity. In addition, the image and color uniformity may be further improved by transmitting the illumination beam LB of different wavebands to different light valves 60 to form the image beam L1 respectively. In this way, the overall structure of the illumination system 100 may be smaller, and cost and noise are reduced, while maintaining good optical effects.

Based on the above, in the illumination system and the projection device of the disclosure, the illumination system includes the excitation light source, the wavelength conversion element, the first light splitting element, the second light splitting element, the first light homogenizing element, and the second light homogenizing element. The excitation light source is configured to provide the laser beam. The wavelength conversion element sequentially converts the laser beam into the at least one excited beam and reflects the laser beam or allows the laser beam to pass through. The first light splitting element is configured to allow the laser beam to pass through, reflect at least a portion of the at least one excited beam to generate the first color beam, and allow at least another portion of the at least one excited beam to pass through. The second light splitting element is configured to allow the laser beam to pass through and reflect at least another portion of the at least one excited beam to generate the second color beam. The first light homogenizing element is disposed on the transmission path of the first color beam. The second light homogenizing element is disposed on the transmission path of the second color beam. The illumination beam includes the first color beam, the second color beam, the and laser beam. The illumination system includes only one single rotating wheel. Therefore, through the above configuration, only one single rotating wheel is used for the illumination system to control the light beams in different wavebands and have good uniformity and color uniformity. In this way, the overall structure of the illumination system may be smaller, and the cost and noise are reduced, while maintaining good optical effects.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. An illumination system configured to provide an illumination beam, wherein the illumination system comprises an excitation light source, a wavelength conversion element, a first light splitting element, a second light splitting element, a first light homogenizing element, and a second light homogenizing element, wherein
the excitation light source is configured to provide a laser beam;
the wavelength conversion element comprises a rotating wheel disposed on a transmission path of the laser beam from the excitation light source, by rotating the rotating wheel, the wavelength conversion sequentially convert the laser beam into at least one excited beam and reflect the laser beam or allow the laser beam to pass through;
the first light splitting element is disposed on the transmission path of the laser beam from the excitation light source and a transmission path of the at least one excited beam from the wavelength conversion element to allow the laser beam to pass through, reflect at least a portion of the at least one excited beam to generate a first color beam, and allow at least another portion of the at least one excited beam to pass through;
the second light splitting element is disposed on the transmission path of the laser beam from the excitation light source and a transmission path of the at least another portion of the at least one excited beam from the wavelength conversion element to allow the laser beam to pass through and reflect the at least another portion of the at least one excited beam to generate a second color beam, wherein a waveband of the at least one excited beam comprises a waveband of the first color beam and a waveband of the second color beam;
the first light homogenizing element is disposed on a transmission path of the first color beam from the first light splitting element; and
the second light homogenizing element is disposed on a transmission path of the second color beam from the second light splitting element, the illumination beam comprises the first color beam, the second color beam, and the laser beam, and the illumination system comprises only the single rotating wheel.

2. The illumination system according to claim 1, wherein the at least one excited beam comprises a first excited beam and a second excited beam, the wavelength conversion element sequentially converts the laser beam into the first excited beam and the second excited beam, a waveband of the first excited beam comprises the waveband of the first color beam, and a waveband of the second excited beam comprises the waveband of the second color beam.

3. The illumination system according to claim 2, wherein the at least one excited beam further comprises a third excited beam, the wavelength conversion element further sequentially converts the laser beam into the third excited beam, the third excited beam at least comprises a first portion and a second portion, the first light splitting element is configured to reflect the first portion of the third excited beam, the second light splitting element is configured to reflect the second portion of the third excited beam, and the illumination beam further comprises the first portion of the third excited beam and the second portion of the third excited beam.

4. The illumination system according to claim 1, wherein a reflection wavelength range of the second light splitting element comprises a reflection wavelength range of the first light splitting element.

5. The illumination system according to claim 1, wherein a light incident surface area of the first light homogenizing element is different from a light incident surface area of the second light homogenizing element.

6. The illumination system according to claim 1, wherein the wavelength conversion element is configured to allow the laser beam to pass through, and the laser beam from the wavelength conversion element passes through the second light splitting element and the second light homogenizing element sequentially.

7. The illumination system according to claim 1, wherein the wavelength conversion element is configured to reflect the laser beam, and the illumination system further comprises a reflective element disposed on the transmission path of the laser beam from the wavelength conversion element to reflect the laser beam, so that the laser beam is reflected by the reflective element and then passes through the second light homogenizing element.

8. The illumination system according to claim 1, further comprising a first filter element and a second filter element, wherein
the first filter element is disposed on the transmission path of the first color beam passing through the first light splitting element and the first light homogenizing element; and
the second filter element is disposed on the transmission path of the second color beam passing through the second light splitting element and the second light homogenizing element.

9. A projection device, comprising an illumination system, at least one light valve, and a projection lens, wherein
the illumination system is configured to provide an illumination beam, comprising an excitation light source, a wavelength conversion element, a first light splitting element, a second light splitting element, a first light homogenizing element, and a second light homogenizing element, wherein
the excitation light source is configured to provide a laser beam;
the wavelength conversion element comprises a rotating wheel disposed on a transmission path of the laser beam from the excitation light source, by rotating the rotating wheel, the wavelength conversion sequentially convert the laser beam into at least one excited beam and reflect the laser beam or allow the laser beam to pass through;
the first light splitting element is disposed on the transmission path of the laser beam from the excitation light source and a transmission path of the at least one excited beam from the wavelength conversion element to allow the laser beam to pass through, reflect at least a portion of the at least one excited beam to generate a first color beam, and allow at least another portion of the at least one excited beam to pass through;
the second light splitting element is disposed on the transmission path of the laser beam from the excitation light source and a transmission path of the at least another portion of the at least one excited beam from the wavelength conversion element to allow the laser beam to pass through and reflect the at least another portion of the at least one excited beam to generate a second color beam, wherein a waveband of the at least one excited beam comprises a waveband of the first color beam and a waveband of the second color beam;
the first light homogenizing element is disposed on a transmission path of the first color beam from the first light splitting element; and
the second light homogenizing element is disposed on a transmission path of the second color beam from the second light splitting element, the illumination beam comprises the first color beam, the second color beam, and the laser beam, and the illumination system comprises only the single rotating wheel;
the at least one light valve is disposed on a transmission path of the illumination beam to convert the illumination beam into an image beam; and
the projection lens is disposed on a transmission path of the image beam to project the image beam out of the projection device.

10. The projection device according to claim 9, wherein the at least one excited beam comprises a first excited beam and a second excited beam, the wavelength conversion element sequentially converts the laser beam into the first excited beam and the second excited beam, a waveband of the first excited beam comprises the waveband of the first color beam, and a waveband of the second excited beam comprises the waveband of the second color beam.

11. The projection device according to claim 10, wherein the at least one excited beam further comprises a third excited beam, the wavelength conversion element further sequentially converts the laser beam into the third excited beam, the third excited beam at least comprises a first portion and a second portion, the first light splitting element is configured to reflect the first portion of the third excited beam, the second light splitting element is configured to reflect the second portion of the third excited beam, and the illumination beam further comprises the first portion of the third excited beam and the second portion of the third excited beam.

12. The projection device according to claim 9, wherein a reflection wavelength range of the second light splitting element comprises a reflection wavelength range of the first light splitting element.

13. The projection device according to claim 9, wherein a light incident surface area of the first light homogenizing element is different from a light incident surface area of the second light homogenizing element.

14. The projection device according to claim 9, wherein the wavelength conversion element is configured to allow the laser beam to pass through, and the laser beam from the wavelength conversion element passes through the second light splitting element and the second light homogenizing element sequentially.

15. The projection device according to claim 9, wherein the wavelength conversion element is configured to reflect the laser beam, and the illumination system further comprises a reflective element disposed on the transmission path of the laser beam from the wavelength conversion element to reflect the laser beam, so that the laser beam is reflected by the reflective element and then passes through the second light homogenizing element.

16. The projection device according to claim 9, wherein the illumination system further comprises a first filter element and a second filter element, the first filter element is disposed on the transmission path of the first color beam passing through the first light splitting element and the first light homogenizing element, and the second filter element is disposed on the transmission path of the second color beam passing through the second light splitting element and the second light homogenizing element.

17. The projection device according to claim 9, wherein the at least one light valve comprises a first light valve and a second light valve, the first light valve is disposed on the transmission path of the illumination beam from the first light homogenizing element, and the second light valve is disposed on the transmission path of the illumination beam from the second light homogenizing element.
